(19) United States
(12) Patent Application Publication
(10) Pub. No.: US 2015/0198142 A1
(43) Pub. Date: Jul. 16, 2015

(54) SEGMENTED ROTOR HUB

(71) Applicant: you WINenergy GmbH, Oldenburg (DE)

(72) Inventor: Rolf Rohden, Aurich (DE)

(73) Assignee: you WINenergy GmbH, Oldenburg (DE)

(21) Appl. No.: 14/420,727

(22) PCT Filed: Aug. 9, 2013
(86) PCT No.: PCT/EP2013/066764

§ 371 Date: Feb. 10, 2015

(30) Foreign Application Priority Data
Aug. 10, 2012 (EP) 12180073.4

(51) Int. Cl. F03D 1/06; F03D 9/00; F03D 1/00

(52) U.S. Cl. CPC F03D 1/0691; F03D 1/0666; F03D 1/001; F03D 9/002

(57) ABSTRACT

The invention relates to a segmented rotor hub for wind turbines, particularly, having an aerodynamic profile on its front side and having a completely open end on the side configured to receive one end of the circumference of a generator rotor, hereinafter referred to as a rear end. The rotor hub comprises plurality of hub segments.

### BACKGROUND OF THE INVENTION

This invention is related to rotor hub for wind turbines.

In the recent years, developments in the wind turbines are directed towards obtaining higher power outputs. Conventionally, higher power output is achieved by increasing the size of the rotor. However, increasing the rotor size also results in an increase in size of the hub, which is not desirable in terms of transportability, and its handling at the site of the wind energy installation. Further, the transportation of a large rotor hub is costly and necessitates extremely extensive logistical resources and preparations. Furthermore, manufacturing a large rotor hub requires expensive manufacturing equipment, such as large machining tools, large amount of materials, such as casts, and more labour. Moreover, upon occurrence of a fault or wear and tear of the existing hubs, the entire hub structure may have to be replaced.

Further, existing rotor hubs are designed having a tetrahedron like profile. Due to such profile of the hub, stress at the corners of the hub is high. To withstand the stress, hubs are generally designed to have a solid core or other strengthening structure made of a material having high tensile strength. Thus, large amount of material is required for manufacturing these hubs. Moreover, such hubs require a cladding in order to provide aerodynamic front surface. This increases the overall cost of the hub.

The following drawbacks are recognized in the art:
Traditional single piece hubs are difficult to handle and transport.
Traditional hubs are triangular in shape. Thus, a cladding is required to cover the hub and to provide aerodynamic shape to the hub.
Traditional hubs are coupled to the rotor of the generator via shaft. Rotation of the hub rotates the shaft that in turn rotates the rotor of the generator.
Due to triangular shape of the traditional hubs, stress at the corners of the hub is observed.
Traditional hubs consist of solid internal core or other strengthening structures to compensate the corner stress and withstand the load, thus, manufacturing cost is high.

### SUMMARY OF THE INVENTION

The invention relates to a segmented rotor hub for wind turbines, particularly, having an aerodynamic profile on its front side and having a completely open end on the side configured to receive one end of the circumference of a generator rotor, hereinafter referred to as a rear end.

The rotor hub comprises plurality of hub segments. Each of the hub segments can be individually manufactured and transported to the erection site. At the erection site, the hub segments can be assembled by joining each of the segmented hub pieces to form the hub. The segmented hub thus formed may enclose a hollow space and is completely open on its back side. As would be appreciated by a person skilled in the art, the plurality of hub segments can be joined by using suitable connecting means known in the art, for example, flanges, bolts, and screws.

As indicated above, each of the hub segments are assembled together to form the hub. The hub segments are designed in such a manner that the assembled hub has an aerodynamic profile on its front end and hollow space with an open end on its rear end. In one implementation, the hub segments are manufactured in such a manner that the hub can have different profiles, for example, a substantially oval profile, a parabolic profile, cone like profile, or semi-spherical profile.

In one implementation, each of the hub segments has at least one parting face. At the time of assembling, the plurality of hub segments is assembled such that the at least one parting face of one hub segment abuts against the at least one parting face of another hub segment. The abutted parting faces can thereafter be joined together by a suitable connecting means, such as flanges, screw and bolt assemblies. Each of the hub segments may include a rotor blade opening for receiving a rotor blade of the wind turbine, which in turn may further include blade flanges being adapted to receive and support the rotor blades. Subsequently, the rotor blades can be positioned into the rotor blade openings. In one implementation, openings and blade flanges may be partly disposed on the hub segment such that a portion of the blade flange in one hub segment abuts against another portion of the blade flange disposed on the another hub segment, to form the complete blade flange.

In one implementation, the rotor hub comprises three hub segments. Each of the hub segments has at least two ends - namely, a rear end facing towards the rotor of the generator, and a front end facing towards the wind. An outer face of the hub segment extends from the rear end and converges towards the front end. Each of the hub segments has one or more parting faces, either extending from the rear end to the front end or across the rotational axis of the rotor hub. Further, each of the hub segments includes a rotor blade opening for receiving a rotor blade of the wind turbine, which in turn may further include blade flanges being adapted to receive and support the rotor blades. At the time of assembling, the plurality of hub segments are assembled in such a manner that the rear ends and the front ends of the hub segments are aligned to each other, and the parting faces of the hub segments abut against each other. The parting faces of the hub segments can be subsequently joined with each other via connecting means, such as flanges and bolt and screw assemblies to form the assembled hub. The rotor blades can thereafter be positioned into the rotor blade openings provided on the hub segments.

In another implementation, the number of hub segments that can be used for forming the segmented hub may differ. For example, in one implementation, the segmented hub may be formed by two hub segments or four hub segments. It may be noted that the hub segments may be similar or dissimilar in shape, size and dimensions depending upon the number of segments to be manufactured and the size of the rotor hub.

In one implementation, a rear end of the assembled hub is adapted to receive the rotor of a generator such that the rotor is directly coupled to the hub. With such an arrangement, the hub directly drives the rotor, thereby eliminating the need for a shaft to drive the rotor. These and other aspects of the subject matter sought to be protected are provided in greater detail in the sections which follow later.

In one implementation, each of the hub segments can be identical in size, shape and dimensions. The number of blade flanges adapted to receive the rotor blades depends on the number of the rotor blades of the wind turbine. Further, the blade flanges may be designed to have an aerodynamic profile, thereby increasing air lift thereof. The blade flanges may be manufactured separately and can either be detachably attached or are integral to the hub.

The hub segments may be connected to each other by means of connecting means, such as flanges, bolt and screw assemblies. The assembly may take place at the erection site of the wind turbine. Thereby, the transport of the hub from the manufacturing site to the erection site is facilitated. Further, the connecting means described above are reversible connecting means that allow the hub segments to be disconnected from each other, during repair and maintenance of the wind turbine.

According to an implementation of the present invention, the hub segments are designed in a manner such that assembly of the hub segments provides aerodynamic profile to the hub. Additionally, a plurality of fins may be disposed on an outer surface of the hub such that the wind directed towards the hub is guided along the at least one fin substantially in the axial direction of the hub. In one embodiment, the fins are disposed in a spaced apart arrangement in a circumferential direction on the outer surface of the hub. With this arrangement of the fins, the heat transfer rate from the fins to an outside atmosphere is improved by a flow of air along the surface of the fins. In one implementation, fins are integral to the hub. In another implementation, the fins can be formed as an element which is separate from the hub and can be detachably attached to the hub. The fins may also be designed to have an aerodynamic profile.

The proposed hub is directed to have improved stability and load bearing capabilities for larger wind turbines. Further, the proposed design of the hub reduces costs and efforts for transportation and handling of the hub, such as during erection of the wind turbine. Furthermore, the proposed hub reduces manufacturing and maintenance costs of the hub.

A segmented hub for a wind turbine having a plurality of hub segments, particularly, three hub segments that can be individually transported to the erection site, and subsequently assembled at the erection site to form a hub, is described. Such a segmented hub provides ease in transportation and handling, and also reduces the associated costs.

Further, the hub segments are designed in such a manner that the assembly of these segments provides aerodynamic shape to the hub. With the aerodynamic shape of the hub, corner stresses that are usually observed in conventional triangular shaped hub are avoided. Therefore, due to the aerodynamic shape, the load is uniformly distributed across the hub, and the hub remains stable. Moreover, the aerodynamic shape of the hub eliminates the need of a cladding.

Further, the hub is hollow from inside, without a provision for attaching a shaft. The hub is designed so as to attach directly to the circumference of the generator rotor thereby eliminating the need for a shaft. With such a feature, it is possible to make the hub hollow from one side and having an aerodynamic shape from another side.

The invention is to cover at least the following concepts which can be combined in any possible manner and which can be supplemented by any information set out in the present document including the text and the drawings:

The invention relates to a segmented rotor hub for wind turbines, particularly, having an aerodynamic profile on its front side and having a completely open end on the side configured to receive one end of the circumference of a generator rotor, hereinafter referred to as a rear end.

The rotor hub comprises plurality of hub segments.

Each of the hub segments can be individually manufactured and transported to the erection site.

At the erection site, the hub segments can be assembled by joining each of the segmented hub pieces to form the hub.

The segmented hub thus formed may enclose a hollow space and is completely open on its back side. As would be appreciated by a person skilled in the art, the plurality of hub segments can be joined by using suitable connecting means known in the art, for example, flanges, bolts, and screws.

As indicated above, each of the hub segments are assembled together to form the hub. The hub segments are designed in such a manner that the assembled hub has an aerodynamic profile on its front end and hollow space with an open end on its rear end.

In one implementation, the hub segments are manufactured in such a manner that the hub can have different profiles, for example, a substantially oval profile, a parabolic profile, cone like profile, or semi-spherical profile.

In one implementation, each of the hub segments has at least one parting face.

At the time of assembling, the plurality of hub segments is assembled such that the at least one parting face of one hub segment abuts against the at least one parting face of another hub segment.

The abutted parting faces can thereafter be joined together by a suitable connecting means, such as flanges, screw and bolt assemblies.

Each of the hub segments may include a rotor blade opening for receiving a rotor blade of the wind turbine, which in turn may further include blade flanges being adapted to receive and support the rotor blades.

Subsequently, the rotor blades can be positioned into the rotor blade openings.

In one implementation, openings and blade flanges may be partly disposed on the hub segment such that a portion of the blade flange in one hub segment abuts against another portion of the blade flange disposed on the another hub segment, to form the complete blade flange.

In one implementation, the rotor hub comprises three hub segments.

Each of the hub segments has at least two ends - namely, a rear end facing towards the rotor of the generator, and a front end facing towards the wind.

An outer face of the hub segment extends from the rear end and converges towards the front end.

Each of the hub segments has one or more parting faces, either extending from the rear end to the front end or across the rotational axis of the rotor hub.

Further, each of the hub segments includes a rotor blade opening for receiving a rotor blade of the wind turbine, which in turn may further include blade flanges being adapted to receive and support the rotor blades.

At the time of assembling, the plurality of hub segments are assembled in such a manner that the rear ends and the front ends of the hub segments are aligned to each other, and the parting faces of the hub segments abut against each other.

The parting faces of the hub segments can be subsequently joined with each other via connecting means, such as flanges and bolt and screw assemblies to form the assembled hub. The rotor blades can thereafter be positioned into the rotor blade openings provided on the hub segments.

In another implementation, the number of hub segments that can be used for forming the segmented hub may differ.

For example, in one implementation, the segmented hub may be formed by two hub segments or four hub segments. It may be noted that the hub segments may be similar or dissimilar in shape, size and dimensions depending upon the number of segments to be manufactured and the size of the rotor hub.

In one implementation, a rear end of the assembled hub is adapted to receive the rotor of a generator such that the rotor is directly coupled to the hub. With such an arrangement, the hub directly drives the rotor, thereby eliminating the need for a shaft to drive the rotor.

In one implementation, each of the hub segments can be identical in size, shape and dimensions.

The number of blade flanges adapted to receive the rotor blades depends on the number of the rotor blades of the wind turbine.

Further, the blade flanges may be designed to have an aerodynamic profile, thereby increasing air lift thereof.

The blade flanges may be manufactured separately and can either be detachably attached or are integral to the hub.

The hub segments may be connected to each other by means of connecting means, such as flanges, bolt and screw assemblies.

The assembly may take place at the erection site of the wind turbine. Thereby, the transport of the hub from the manufacturing site to the erection site is facilitated.

Further, the connecting means described above are reversible connecting means that allow the hub segments to be disconnected from each other, during repair and maintenance of the wind turbine.

According to an implementation of the present invention, the hub segments are designed in a manner such that assembly of the hub segments provides aerodynamic profile to the hub.

Additionally, a plurality of fins may be disposed on an outer surface of the hub such that the wind directed towards the hub is guided along the at least one fin substantially in the axial direction of the hub. In one embodiment, the fins are disposed in a spaced apart arrangement in a circumferential direction on the outer surface of the hub. With this arrangement of the fins, the heat transfer rate from the fins to an outside atmosphere is improved by a flow of air along the surface of the fins. In one implementation, fins are integral to the hub.

In another implementation, the fins can be formed as an element which is separate from the hub and can be detachably attached to the hub.

The fins may also be designed to have an aerodynamic profile.

These and other aspects of the subject matter sought to be protected are provided in greater detail in the explained embodiment.

At least the following effects or advantages are achievable with the invention:

Segmented hub provides ease of manufacturing, handling, and transportation, as each of the individual hub segments can be independently manufactured and transported to the erection site, where these segments can be assembled to form the hub.

In the event of fault or wear and tear of the hub, only the hub segment affected by the fault and/or wear and tear can be replaced with a new segment, thereby providing ease of maintenance.

Design of the hub segments provides aerodynamic profile to the hub, when assembled. The aerodynamic profile improves heat dissipation through the hub, and facilitates load distribution across the hub. Corner stresses as observed in traditional hubs are avoided.

The hub of the present invention does not require a cladding.

The hub directly drives the rotor of the generator, thereby eliminating need of a shaft to drive the rotor. Therefore, the hub can be made hollow from the rear side.

The hub is hollow form inside, thereby saving manufacturing cost.

Aerodynamically profiled flanges are provided on the hub for receiving the rotor blades. Such aerodynamically profiled flanges increase air drag.

A plurality of fins is provided on the outer surface of the hub, and possibly on the rotor housing, for dissipating heat thereof.

Moreover, at least the following effects and advantages are achievable with the invention:

Hub is manufactured in a plurality of hub segments, where each of the hub segments can be individually transported to the erection site for assembly.

Hub is designed to provide an aerodynamic shape. Thus, cladding is not required.

Hub is directly coupled to the rotor, thereby eliminating need of a shaft.

No corner stresses.

Hollow internal portion, thereby saving manufacturing cost.

### BRIEF DESCRIPTION OF THE DRAWINGS

FIG. 1 illustrates a wind turbine with a segmented rotor hub;

FIG. 2 illustrates a perspective view of the segmented hub, according to an embodiment of the subject matter sought to be protected;

FIGS. 3a-3f illustrate a perspective views of the segmented hub, according to another embodiment of the subject matter sought to be protected.

### EMBODIMENT

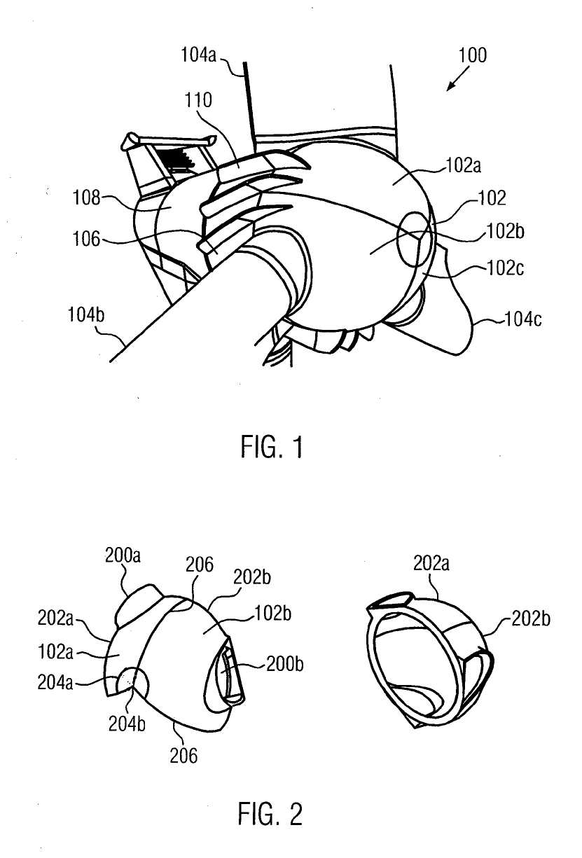

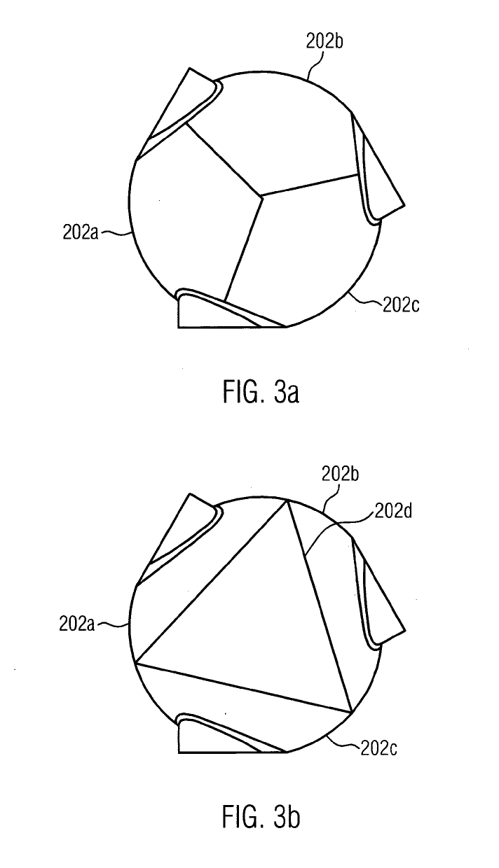

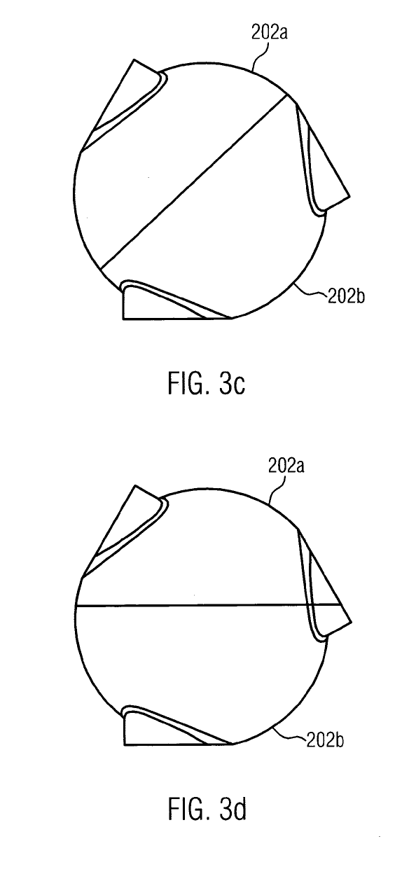

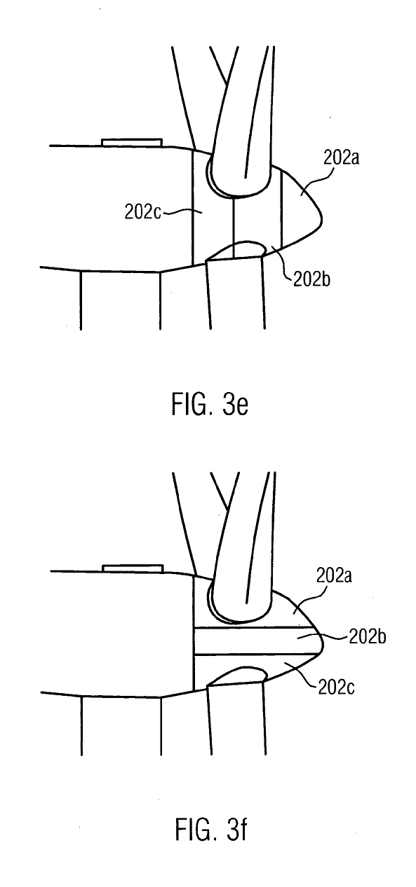

FIG. 1 illustrates a wind turbine comprising the segmented rotor hub assembled with the blades and nacelle. FIG. 2 illustrates a perspective view of the segmented hub, in accordance with one embodiment of the subject matter sought to be protected. FIG. 3a-3f depicts perspective view of the segmented hub, in accordance with other embodiments of the subject matter sought to be protected. The present description of the subject matter sought to be protected, is provided in conjunction with FIGS. 1-3.

As shown in FIG. 1, the wind turbine 100 includes a hub 102 rotatably coupled to a rotor 106 of a generator, wherein a stator of the generator is structurally attached to the nacelle 108. Thus, the hub, the generator and the nacelle cooperates with each other. The hub 102 comprises a plurality of hub segments 102a, 102b, and 102c. Each of the hub segments 102a, 102b, and 102c that can be individually manufactured and transported to the erection site, where these hub segments 102a, 102b, and 102c can be assembled to form the hub 102. As indicated previously, the hub segments 102a, 102b, and 102c when assembled provides an aerodynamic shape to the hub 102. A plurality of fins 110 is disposed on an outer surface of the hub and/or rotor to function as heat sink for dissipating heat from the hub and the rotor. Additionally, the fins 110 acts as an air guide for guiding the air to the heat exchanger disposed at the back of the nacelle.

The construction of the segmented hub is now described with reference to FIG.

2. FIG. 2 depicts a segmented hub which is formed from three hub segments. The illustration as depicted in FIG. 2 relates only to one possible embodiment.

In FIG. 2, as per one implementation, each of the hub segments 102a, 102b, 102c include rear end 202a, 202b, 202c, and front end 204a, 204b, 204c, respectively. Furthermore each of the hub segments 102 may include at least two parting faces, say, parting faces 206. When assembled, each of the hub segments 102 are joined such that parting faces 206 of a hub segment, say, hub segment 102a are completely abutted against the corresponding parting faces 206 of the adjacent hub segments 102b and 102c. As should be noted, the hub segments 102b and 102c will also in turn be abutted with hub segments 102a and 102c, and 102a and 102b, respectively. Furthermore, when assembled together each of the front ends, i.e., front ends 204a, 204b, and 204c, converge towards each other. As depicted in FIGS. 1 and 2, the front ends 204 may be a point or may be edges formed on each of the hub segments 102.

The hub segments 102a, 102b and 102c can be assembled by suitable connection means to form the hub 102. The hub segments 102a, 102b, 102c includes openings 200a, 200b and 200c and aerodynamically profiled blade flanges for receiving the rotor blades 104a, 104b and 104c therein.

The hub 102, as shown in the figure, is hollow from inside. It should be noted that in such cases, manufacturing of the hub will involve less material for manufacturing and hence would be cost effective. The high strength material for manufacturing each of the hub segments 102a, 102b and 102c can be chosen accordingly. In an alternative embodiment, the hub 102 may be provided with supporting guides (not shown in the figure) either on the inside or an outside portion of the hub that provides additional strength to the hub 102.

FIG. 3a-3f depicts perspective view of the segmented hub 102, according to other possible embodiments.

FIG. 3a depicts an embodiment of the hub 102 comprising three hub segments 202a, 202b, and 202c. Each of the hub segments 202a, 202b, and 202c include a front end and a rear end. The front ends of the hub segments 202a, 202b and 202c include portions of the blade flanges. While assembling, a portion of the blade flange on one hub segment abuts against corresponding mating portion of the blade flange on the adjacent hub segment.

FIG. 3b depicts another embodiment of the hub 102 comprising four hub segments 202a, 202b, 202c, and 202d. The hub segment 202d which is triangular in shape forms a central outer portion of the hub 102 that is surrounded by three identical arc shaped hub segments 202a, 202b, and 202c. Each of the three hub segments 202a, 202b, and 202c includes a blade flange adapted to receive and support the rotor blade therein.

FIG. 3c depicts another embodiment of the hub 102 comprising two hub segments 202a and 202b. When assembled, parting faces of the hub segments 202a and 202b that abut against each other diagonally intersect a rotational axis of the hub 202. The hub segment 202a includes one blade flange, while, the hub segment 202b includes two blade flanges adapted to receive and support the rotor blades.

FIG. 3d depicts another embodiment of the hub 102 comprising two hub segments 202a and 202b. In an assembled state, parting faces of the hub segments 202a and 202b that abut against each other lie across a central axis of the hub. In said embodiment, each of the hub segments 202a and 202b includes a complete blade flange and a portion of another blade flange. Such portions of the blade flanges abut against each other during assembly, forming the complete blade flange.

FIG. 3e depicts another embodiment of the hub 102 comprising three hub segments 202a, 202b, and 202c. The hub segments 202a, 202b, and 202c are manufactured and arranged in such a manner that the plane in which the parting faces of the hub segments 202a, 202b, and 202c lie intersects the rotational axis of the hub. In such a case, the hub segment 202a is positioned such that it faces in the windward direction, whereas the hub segment 202c is positioned near the rotor of the generator, in the leeward direction. The hub segment 202b lies in between the hub segments 202a and 202c.

FIG. 3f depicts another embodiment of the hub 102 comprising three hub segments 202a, 202b, and 202c. The hub segments 202a, 202b, and 202c are manufactured and arranged in such a manner that the hub segment 202a, 202b, and 202c are placed one after the another with their parting faces lying parallel to the rotational axis of the hub. The hub segment 202b lies between the hub segments 202a and 202b. Accordingly, the hub segment 202b includes two parting faces, wherein each parting face abuts against a parting face of the hub segment 202a and 202c.

The description above is explained with reference to different embodiments of the segmented hub according to FIGS. 1-3. These embodiments, however, should not be construed as a limitation. The hub may comprise of any number of hub segments for the ease of manufacturing and transport. Further, design and arrangement of the hub segments to form an assembled hub may also vary, and the same would be covered within the scope of the subject matter sought to be protected.

The segmented hub according to the present subject matter has many advantages over the traditional hubs. Some of these advantages are described below in the forthcoming description.

In contrast to the conventional single piece rotor hubs, which are difficult to handle and transport, the rotor hub of the present invention is easier to handle and transport. Further, the hub can be manufactured in segments, the need of expensive machining tools and extensive labour is eliminated, thereby saving manufacturing cost of the hub. Also, in case of occurrence of any fault and wear and tear of the hub, replacement of entire hub may not be required. Only the segment of the hub that is influenced by the fault and wear and tear can be replaced with a new segment. Thus, the hub provides ease of maintenance.

Further, the design of the hub segments itself provides an aerodynamic profile to the hub when assembled; a cladding that is used in conventional triangular shaped rotor hubs to cover the hub and provide the hub with an aerodynamic shape is not required. As such, the air is made to flow over the hub thereby facilitating as a heat sink to dissipate heat from inside of the hub and nacelle. Additionally, due to aerodynamic shape of the rotor hub, corner stresses that are usually observed in conventional triangular shaped rotor hubs are avoided. The aerodynamic profile of the hub provides better load distribution across the hub. Further, as the hub is directly coupled to the rotor circumference, the hub can be made hollow, thus saving the material. Thus, the hub of the present invention is cost-effective, provides ease of manufacturing, transportation, handling and maintenance, and possess better load bearing capabilities.

1. A rotor hub (102, 202) for a wind turbine (100), said rotor hub (102) being formed by at least two hub segments (202a, 202b, 202c), and said rotor hub (102) comprising a hollow enclosure and a front surface facing toward wind when in operation, wherein said front surface of said rotor hub (102) is provided with an aerodynamic profile.

2. The rotor hub (102, 202) according to claim 1, wherein each of said hub segments (202a, 202b, 202c) has at least one parting face (206), wherein for assembling said rotor hub (102), said hub segments (202a, 202b, 202c) are assembled such that the at least one parting face (206) of one hub segment (202a, 202b,202c) abuts against the at least one parting face (206) of another hub segment (202a, 202b, 202c).

3. The rotor hub (102, 202) according to claim 2, wherein the at least one parting face (206) of one hub segment (202a, 202b,202c) is removably assembled against the at least one parting face (206) of another hub segment (202a, 202b, 202c) by one or more fastening elements.

4. The rotor hub (102, 202) according to claim 3, wherein the fastening elements include flanges.

5. The rotor hub (102, 202) according to claim 1, wherein said hub segments (202a, 202b, 202c) includes rotor blade openings (200a, 200b, 200c) for receiving rotor blades (104a, 104b, 104c) of the wind turbine (100), and wherein said rotor blade openings include (200a, 200b, 200c) blade flanges being adapted to receive and support said rotor blades (104a, 104b, 104c).

6. The rotor hub (102, 202) according to claim 5, wherein said rotor blade openings (200a, 200b, 200c) (100) and said blade flanges are partly disposed on one of said hub segments (202a, 202b, 202c) such that a portion of the blade flange in one hub segment (202a) abuts against another portion of the blade flange disposed on the another hub segment (202b), to form the complete blade flange.

7. The rotor hub (102, 202) according to claim 5, wherein said blade flanges are designed to have an aerodynamic profile for increasing an air lift thereof.

8. The rotor hub (102, 202) according to claim 5, wherein said blade flanges are manufactured separately and are either detachably attached to said rotor hub or are integral to said rotor hub.

9. The rotor hub (102, 202) according to claim 1, further comprising an configured to receive one end of a generator rotor.

10. The rotor hub (102, 202) according to claim 1, wherein each of said hub segments (202a, 202b, 202c) has one or more parting faces (206) extending from a rear end to a front end of said rotor hub (102, 202).

11. The rotor hub (102, 202) according to claim 1, wherein each of said hub segments (202a, 202b, 202c, 202d) has one or more parting faces (206) extending across a rotational axis of the rotor hub (102, 202).

12. The rotor hub (102, 202) according to claim 1, wherein each of said hub segments (202a, 202b, 202c) is identical in size, shape and dimensions.

13. The rotor hub (102, 202) according to claim 1, wherein a rear end of the rotor hub (102; 202) is adapted to receive a rotor of a generator such that the rotor is directly coupled to said rotor hub (102; 202).

14. The rotor hub (102, 202) according to claim 1, wherein each of the hub segments (202a, 202b, 202c) has a rear end facing towards a rotor of the generator when mounted, and a front end facing towards wind when mounted, wherein an outer face of each of said hub segments (202a, 202b, 202c) extends from the rear end and converges towards the front end.

15. The rotor hub (102, 202) according to claim 1, wherein a plurality of fins (110) is disposed on an outer surface of the rotor hub (102, 202) such that wind directed towards said rotor hub (102, 202) is guided along at least one of the fins (110) substantially in an axial direction of said rotor hub (102, 202).

16. The rotor hub (102, 202) according to claim 15, wherein said fins (110) are disposed in a spaced apart arrangement in a circumferential direction on said outer surface of said rotor hub (102, 202).

17. The rotor hub (102, 202) according to claim 1, wherein said rotor hub (102) being formed by three hub segments (202a, 202b, 202c).

18. A wind turbine (100) comprising a generator, and a plurality of blades (104a, 104b, 104c), and a rotor hub (102, 202) according to claim 1, wherein said blades (104a, 104b, 104c) are mounted to said rotor hub (102; 202) and said rotor hub is connected to a rotor of said generator.
